(19) United States
(12) Patent Application Publication
(10) Pub. No.: US 2009/0259322 A1
(43) Pub. Date: Oct. 15, 2009

(54) Automation system and method for the diagnosis, adjustment or optimization of an automation device

(76) Inventors: Mirko Danz, Erlangen (DE); Johannes Extra, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/383,964

(22) Filed: Mar. 31, 2009

(30) Foreign Application Priority Data
Apr. 10, 2008 (EP) 08007143.4

(51) Int. Cl. G05B 19/18; G06F 15/00

(52) U.S. Cl. 700/9; 702/184

(57) ABSTRACT

An automation system having an automation device for realizing a plurality of automation functions and a control device for controlling the automation device is disclosed. The control device has a plurality of data records with handling instructions for several different types of automation devices. Further, the automation system has a communication network for a communication between the control device and the automation device, the control device being configured to identify connected automation devices in the communication network, to read out the automation functions from the identified automation devices, to identify at least one data record for each identified automation device with the aid of the read-out automation functions, and to initiate each identified automation device for execution of the handling instructions of the at least one identified data record.

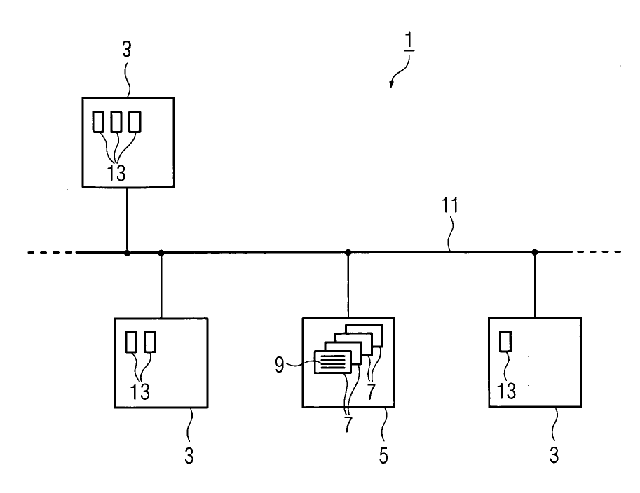

### CROSS REFERENCE TO RELATED APPLICATIONS

This application claims priority of European Patent Application No. 08007143.4 EP filed Apr. 10, 2008, which is incorporated by reference herein in its entirety.

### FIELD OF INVENTION

The invention relates to an automation system comprising at least one, but preferably a number of automation devices.

### BACKGROUND OF INVENTION

More and more complex automation systems are increasingly being used to control complex technical facilities. When planning a modern technical facility, comprehensive planning of the automation system for the technical facility therefore must also be undertaken. The automation system is itself integrated in what is normally an equally somewhat complex communication network so that the smooth exchange of data and the interaction between the automation devices are assured. Since the requirements of the technical facility and therefore of the automation system are not rigid but instead normally highly flexible, a frequent review, diagnosis or adjustment of the automation functionality of the automation system is necessary.

For example it may be necessary to provide additional automation devices in order to fulfill further automation tasks. Or in the context of error diagnosis it may be necessary to perform a system-wide diagnosis in order to detect a system malfunction. It may also be necessary to modify or optimize automation functions realized in certain automation devices in order to facilitate the overall technical process. In automated processes the recording of production data is organized in the individual automation devices. It may be necessary to collect and archive this production data, e.g. batch identification numbers, at a central location. Finally software maintenance for the automation system is an important aspect of preserving the function and value of the automation system.

The use of various separate tools in order to fulfill these and many other tasks of the automation system is known. For example there are engineering systems for setting up and building up communications links within the automation system to the various automation devices. For example, a “life list” function is available for identifying new communication subscribers. Diagnostic software tools can additionally be used in order to determine status information for the automation system and identify any errors. Finally FTP (File Transfer Protocol) functions are known for the transfer of data in the automation system, for example in order to transmit programs and data.

### SUMMARY OF INVENTION

Until now the automation system user has had to manually select and deploy the appropriate tool for this purpose in a targeted manner, based on the current task at hand.

However this manual procedure is error-prone since it relies heavily on the intuition and experience of the user, who has to perform repetitive, routine tasks.

An object of the invention is to specify an automation system that can react largely independently to changes in its topology or automation functions, and in particular that initiates the necessary diagnostic and/or optimization measures.

The object is achieved by an automation system comprising the following components:

At least one automation device for realizing a number of automation functions,
a control device for controlling the at least one automation device, with the control device comprising a number of data records with handling instructions for several different types of automation device with corresponding automation functions, with the control device itself being realized as an automation device (3) as required, and
a communication network for communication between the control device and the at least one automation device, with the control device being configured to identify connected automation devices in the communication network, to read out the automation functions from the identified automation devices, to identify at least one data record for each identified automation device with the aid of the read-out automation functions, and to initiate and/or execute, if the control device (5) is itself realized as an automation device (5), each identified automation device for execution of the handling instructions of the at least one identified data record.

The invention is based on the idea of holding a catalog of handling instructions for several different types of automation device within the automation system, and indeed on the control device, so that after identification of the automation functions of a newly-connected automation device, for example, the type of said newly-connected automation device can be inferred whereupon, from among the catalog of handling instructions stored on the control device in the form of a number of data records, the correct and required handling instructions can be selected and automatically set to run on the automation device or on the control device itself, if the latter is itself realized as an automation device.

Naturally the data records with the handling instructions for several different types of automation device can themselves also be stored on a separate database, so the control device within the meaning of the claim is also to be understood as a function.

The handling instructions preferably comprise the following activities:
Reading-out of data from the automation device by the control device,
Processing of the read-out data into processing results by the control device, and
Writing of the processing results into the automation device by the control device.

The processing results can also serve to search for additional handling instructions by means of the automation device with the aid of the processing results in the control device, and to load said handling instructions into the automation device.

The automation functions of the automation device(s) can relate to a production process for example, and the handling instructions can comprise the reading-out of production data of the production process as well as the writing of processed production data to the automation device.

The processed production data preferably comprises here a formulation of the production process and/or a control program for the production process and/or a maintenance program for the automation device.

In the latter embodiments the production process that is controlled by the automation device is optimized automatically through the existing handling instructions in the data records of the control device being detected, which are appropriate to the automation device(s), and through transmission to and execution by the executing entity in the context of an optimization of the overall process.

For example the formulation and/or the control program contribute to improving the production process. The maintenance program ensures that the automation device(s) is/are fully functional.

Further embodiments of the invention relate to, for example, the diagnosis of the automation system, with the handling instructions comprising the reading-out of device and/or operating status information of the automation device(s).

Furthermore the handling instructions preferably include the loading of a repair program into the automation device, with the repair program being adjusted in accordance with defects discovered in the device and/or operating status information.

The handling instructions can additionally perform a diagnosis with the aid of the device and/or operating status information and display the results of the diagnosis accordingly.

The data records of the control device comprise for example a large number of different error scenarios and the remediation of those errors. Should a problem now arise in an automation device, its type can now be determined by reading out the automation device's automation function and, by reading out its operating and/or status information, the possible troubleshooting routines can be identified and executed in the handling instructions of the identified data records.

The invention further leads to a method for the diagnosis, adjustment or optimization of at least one automation device, with the automation device being connected to a communication network and providing a number of automation functions, comprising the following steps:
Provision of a control device for controlling the at least one automation device, with the control device comprising a number of data records with handling instructions for several different types of automation device with corresponding automation functions,
Connection of the control device to the communication network,
Identification by the control device of automation devices connected in the communication network,
Reading-out by the control device of the automation functions of the identified automation devices,
Identification of at least one data record for each identified automation device with the aid of the read-out automation functions, and
Initiation by the control device of each identified automation device for the execution of the handling instructions of the at least one identified data record, with the control device (5) being able to execute the handling instructions itself, if it is realized as an automation device (3).

Preferred embodiments are set out in the corresponding dependent claims.

### BRIEF DESCRIPTION OF THE DRAWING

An exemplary embodiment of the invention is described in more detail below.

The FIGURE shows an automation system.

### DETAILED DESCRIPTION OF INVENTION

An automation system 1 comprises a number of automation devices 3 as well as a control device 5, which are connected to one another by means of a communication network 11. The communication network 11 is a bus system for example, e.g. PCI.

The automation devices 3 are configured to control a technical process and each comprises automation functions 13.

The automation devices 3 are of differing types, a fact which manifests itself for example in the differing automation functions 13 provided by each of the automation devices 3.

The control device 5 comprises a number of data records 7 that comprise handling instructions 9 for the automation devices 3. In this context the data records 7 can be stored directly on the control device 5 or in a separate database.

The control device 5 is configured to identify the automation devices 3 connected to the communication network 11 or newly added, by reading out the automation functions 13 of each of the automation devices 3 and thereby recognizing the type of each automation device 3.

Since the data records 7 comprise handling instructions 9 for several different types of automation device, the control device 5 can now identify, with the aid of the read-out automation functions 13, the handling instructions 9 adjusted to the correspondingly identified type of automation device 3 and can automatically set said handling instructions to run on the relevant automation device 3 and/or on the control device 5, if the latter is itself realized as an automation device.

For example the control device 5 can search for automation devices 3 in the communication network 11 on a cyclical basis. As soon as the control device 5 finds a new automation device 3, said control device 5 reads out the automation functions 13 from said automation device 3. These automation functions 13 represent the type of automation device 3. Information that comprises the aforementioned handling instructions 9 is stored in the data records 7 of the control device 5 in addition to the read-out automation functions 13. And the control device 5 can now automatically and independently execute these handling instructions 9 by means of the automation device 3.

This may involve diagnosing the device status of the automation device(s) 3, for example. It may additionally involve reading an up-to-date status of the automation task currently being processed by the automation device 3. The control device 5 can also read out e.g. production data from the automation device 3, such as batch information or formulations. In addition to reading data from the automation device(s) 3 the control device can also load data into these automation devices 3, such as new formulations, control programs, additional data and so on. Finally maintenance and/or repair programs can also be loaded into the automation devices 3 for the remediation of defects.

1-12. (canceled)

13. An automation system, comprising:
an automation device configured to realize a plurality of automation functions;
a control device configured to control the automation device, the control device having a plurality of data records containing handling instructions for several different types of automation devices having automation functions, and the control device itself being configured as the automation device when required; and
a communication network for communication between the control device and the automation device,
wherein the control device is configured
to identify connected automation devices of the communication network,
to read out the automation functions from the identified automation devices,
to identify at least one data record for each identified automation device with the aid of the read-out automation functions, and
to initiate each identified automation device for execution of the handling instructions of the at least one identified data record.

14. The automation system as claimed in claim 13, wherein the control device, when configured as the automation device, executes the handling instructions of the at least one identified data record for each identified automation device.

15. The automation system as claimed in claim 13, wherein the handling instructions comprise the following activities:
reading-out of data from the automation device by the control device,
processing of the read-out data into processing results by the control device, and
writing of the processing results or of data records derived from the processing results into the automation device by the control device.

16. The automation system as claimed in claim 13, wherein the automation functions of the automation device relate to a production process, and the handling instructions comprise the reading-out of production data of the production process as well as the writing of processed production data to the automation device.

17. The automation system as claimed in claim 15, wherein the automation functions of the automation device relate to a production process, and the handling instructions comprise the reading-out of production data of the production process as well as the writing of processed production data to the automation device.

18. The automation system as claimed in claim 16, wherein the processed production data comprise data selected from the group consisting of a formulation of the production process, a control program for the production process, a maintenance program for the automation device and a combination thereof.

19. The automation system as claimed in claim 17, wherein the processed production data comprise data selected from the group consisting of a formulation of the production process, a control program for the production process, a maintenance program for the automation device and a combination thereof.

20. The automation system as claimed in claim 13, wherein the handling instructions comprise the reading-out of device status information of the automation device.

21. The automation system as claimed in claim 13, wherein the handling instructions comprise the reading-out of operating status information of the automation device.

22. The automation system as claimed in claim 20, wherein the handling instructions furthermore include the loading of a repair program into the automation device, the repair program being adjusted in accordance with defects discovered in the device and/or operating status information.

23. The automation system as claimed in claim 21, wherein the handling instructions furthermore include the loading of a repair program into the automation device, the repair program being adjusted in accordance with defects discovered in the device and/or operating status information.

24. A method for diagnosis, adjustment or optimization of an automation device, the automation device being connected to a communication network and providing a plurality of automation functions, comprising:
providing a control device for controlling the automation device, the control device having a plurality of data records containing handling instructions for several different types of automation devices having automation functions, the control device itself being configured as the automation device when required;
connecting the control device to the communication network;
identifying connected automation devices of the communication network by the control device;
reading-out the automation functions of the identified automation devices by the control device;
identifying at least one data record for each identified automation device by the read-out automation functions; and
initiating each identified automation device for execution of the handling instructions of the at least one identified data record by the control device.

25. The method as claimed in claim 24, wherein the control device executes the handling instructions itself, when the control device is configured as the automation device.

26. The method as claimed in claim 24, wherein the handling instructions comprise the following activities:
reading-out data from the automation device by the control device,
processing the read-out data into processing results by the control device, and
writing the processing results into the automation device by the control device.

27. The method as claimed in claim 24, wherein the automation functions of the automation device relate to a production process, and the handling instructions comprise the reading-out of production data of the production process as well as the writing of processed production data to the automation device.

28. The method as claimed in claim 26, wherein the automation functions of the automation device relate to a production process, and the handling instructions comprise the reading-out of production data of the production process as well as the writing of processed production data to the automation device.

29. The method as claimed in claim 27, wherein the processed production data comprise data selected from the group consisting of a formulation of the production process, a control program for the production process, a maintenance program for the automation device and a combination thereof.

30. The method as claimed in claim 28, wherein the processed production data comprise data selected from the group consisting of a formulation of the production process, a control program for the production process, a maintenance program for the automation device and a combination thereof.

31. The method as claimed in claim 24, wherein the handling instructions comprise the reading-out of device and/or operating status information of the automation device.

32. The method as claimed in claim 31, wherein the handling instructions furthermore include the loading of a repair program into the automation device, the repair program being adjusted in accordance with defects discovered in the device and/or operating status information.
